(19) United States
(12) Patent Application Publication
(10) Pub. No.: US 2026/0177740 A1
(43) Pub. Date: Jun. 25, 2026

(54) HOLLOW-CORE ASSEMBLY WITH LOSSY GLASS

(71) Applicant: CORNING INCORPORATED, CORNING, NY (US)

(72) Inventor: Ming-Jun Li, Horseheads, NY (US)

(21) Appl. No.: 19/413,196

(22) Filed: Dec. 9, 2025

Related U.S. Application Data
(60) Provisional application No. 63/736,946, filed on Dec. 20, 2024.

(51) Int. Cl. G02B 6/02; C03B 37/012; C03B 37/025

(52) U.S. Cl. CPC G02B 6/02328; C03B 37/0122; C03B 37/0256; G02B 6/02347; G02B 6/0238; C03B 2203/16; C03B 2205/12; C03C 2201/06

(57) ABSTRACT

Materials and methods of making hollow-core assemblies and hollow-core optical fibers drawn from the assemblies is disclosed. The hollow-core assembly includes a cladding tube with one or more primary capillaries disposed therein. The primary capillaries are fused to an inner surface of the cladding tube and preferably include a nested capillary disposed therein. The hollow-core assembly is preferably made at least in part from lossy glass. Lossy glass is glass having an absorption coefficient greater than the absorption coefficient of pure silica at a wavelength λ. Lossy glass also has a softening point less than the softening point of pure silica. The methods include forming hollow-core assemblies that include lossy glass, redraw of hollow-core assemblies that include lossy glass, and drawing of hollow-core optical fibers drawn from hollow-core assemblies that include lossy glass.

This application claims the benefit of priority to U.S. Provisional Patent Application Ser. No. 63/736,946 filed on Dec. 20, 2024, the content of which is relied upon and incorporated herein by reference in its entirety.

### FIELD

This description pertains to hollow-core assemblies. More particularly, this description pertains to hollow-core assemblies constructed in least in part from glass having a softening point less than the softening point of pure silica glass. Most particularly, this description pertains to hollow-core assemblies constructed in least in part from lossy glass, where lossy glass is glass that weakly absorbs optical signals.

### BACKGROUND

Optical fibers are utilized to transmit data. More particularly, a transmitter converts information into pulses of electromagnetic radiation and transmits the pulses into the optical fiber. The electromagnetic radiation transmits along the optical fiber to a receiver. The receiver re-converts the pulses of electromagnetic radiation back into information.

Conventional optical fiber includes a solid core through which the electromagnetic radiation moves and a cladding surrounding the solid core to maintain the electromagnetic radiation within the solid core. The cladding and the solid core exhibit different indices of refraction, and the difference in refractive index confines the electromagnetic radiation to the solid core during transmission due to total internal reflection. The solid core of the optical fiber is often formed of silica-based glass.

Transmission performance of optical fibers with a solid core can suffer from confinement loss and losses due to scattering, absorption, and bending losses. Imperfection in the material of the solid core can cause scattering and absorption of the electromagnetic radiation pulses that the optical fiber is transmitting. Further, losses of the intensity of the electromagnetic radiation from the core into the cladding occur due to external perturbations, such as bending and stresses when optical fibers are packed and deployed in cables. Confinement losses result from leaky modes in the optical fiber. Leaky modes have evanescent fields of optical signal intensity that extend beyond the core into the cladding. Losses due to scattering, absorption, and lack of confinement reduce the power of the electromagnetic radiation pulses. Reduced power limits the ability of the receiver to convert the pulses back into information, which limits the reach of the optical fiber.

In an effort to improve the performance of optical fibers, hollow-core optical fibers have recently been proposed. Hollow-core optical fibers do not include a core of solid material. Instead, the core is an open space filled with a gas, such as air. Hollow-core optical fibers mitigate attenuation of optical signals and provide further advantages such as low non-linearity, low dispersion, and low latency. The absence of a solid core has been demonstrated to reduce attenuation losses to levels below those observed in conventional optical fibers.

The mechanism of confinement in hollow-core optical fibers is based upon anti-resonance effects in the cladding structure. Such optical fibers are referred to as anti-resonant hollow-core optical fibers (AR-HCFs). With AR-HCFs, a central hollow core is surrounded by anti-resonant cladding elements contained in a cladding tube. The anti-resonant cladding elements are typically glass elements with a thickness capable of providing an anti-resonant effect that prevents or mitigates leakage of core modes into the cladding. Anti-resonance occurs when electromagnetic radiation incident to an anti-resonant cladding element destructively interferes with itself, resulting in minimal transmission of optical power through the anti-resonant element and minimal transfer of optical power from the core to the cladding. The greater the anti-resonant effect of the cladding elements, the greater the confinement of the electromagnetic radiation within the core, and thus the lower the confinement loss.

Hollow-core assemblies include hollow-core blanks, hollow-core preforms, and hollow-core optical fibers. Hollow-core optical fibers are formed from a hollow-core blank or a hollow-core preform in a fiber draw process. The hollow-core blank or hollow-core preform has the same elements and configuration as hollow-core optical fibers drawn from it. The hollow-core blank or hollow-core preform, however, is a scaled-up version of the hollow-core optical fiber with larger dimensions of corresponding elements. In the fiber draw process, an end portion of the hollow-core blank or hollow-core preform is heated and softened. Tension is applied to the softened end and a hollow-core optical fiber is drawn by pulling and thinning the hollow-core blank or hollow-core preform to desired reduced dimensions. Structural elements in the hollow-core blank or hollow-core preform are scaled down during draw to form corresponding elements in the hollow-core optical fiber.

Hollow-core assemblies are constructed from glass. It is widely believed that pure silica glass is the most advantageous material for hollow-core assemblies as it is in the conventional solid core assemblies. The prevailing consensus is that the presence of impurities, modifiers, or dopants in silica glass leads to a deterioration in the performance of hollow-core optical fibers and render them unsuitable for practical application. Construction of hollow-core assemblies from high purity silica glass, however, has two significant drawbacks: (1) cost—high purity silica glass is expensive and difficult to fabricate with the required purity and the required degree of geometric precision; and (2) demanding processing conditions for drawing hollow-core optical fibers—high purity silica glass has a high softening point. The high cost of raw materials and demanding processing conditions will increase the fiber process complexity and fiber cost, which will delay development and market acceptance of hollow-core optical fibers. There is currently a need for raw materials suitable for use in hollow-core assemblies that are economical and capable of being fabricated at convenient processing conditions.

### SUMMARY

Materials and methods of making a hollow-core assembly are disclosed. The hollow-core assembly includes a cladding tube with one or more primary capillaries disposed therein. The primary capillaries are fused to an inner surface of the cladding tube and preferably include a nested capillary disposed therein. The hollow-core assembly is preferably made at least in part from extrinsic silica glass. Extrinsic silica glass is silica glass that includes a modifier, dopant, or impurity that leads to a reduction in softening point relative to pure silica glass. The methods disclosed herein include forming hollow-core blanks that include extrinsic silica glass, redraw of hollow-core blanks that include extrinsic silica glass to form hollow-core preforms that include extrinsic silica, and drawing of hollow-core optical fibers from hollow-core blanks or hollow-core preforms that include extrinsic silica.

The present disclosure extends to:
A hollow-core assembly comprising:
   a central longitudinal axis extending from a first end to a second end;
   a cladding tube extending from the first end to the second end azimuthally around the central longitudinal axis, the cladding tube comprising (i) a cladding outer surface at a cladding outer radius from the central longitudinal axis, and (ii) a cladding inner surface at a cladding inner radius from the central longitudinal axis;
   a plurality of primary capillaries arranged azimuthally around the central longitudinal axis, each of the plurality of primary capillaries directly contacting the cladding inner surface and comprising (i) a primary capillary longitudinal axis that is parallel to the central longitudinal axis (ii) a primary capillary outer surface at a primary capillary outer radius from the primary capillary longitudinal axis, (iii) a primary capillary inner surface at a primary capillary inner radius from the primary capillary longitudinal axis and (iv) a primary capillary thickness; and
   an effective core region tangential to the plurality of primary capillaries having a core radius from the central longitudinal axis, the plurality of primary capillaries disposed radially outward of the effective core region;
   wherein the cladding tube or at least one of the plurality of primary capillaries comprises lossy glass, the lossy glass comprising an oxide and having an absorption coefficient a(λ) at a wavelength λ greater than 1×10⁻¹², the wavelength λ in the range from 800 nm to 2000 nm.

The present disclosure extends to:
A method of making a hollow-core optical fiber comprising:
   heating a hollow-core assembly, the hollow-core assembly comprising:
      a central longitudinal axis extending from a first end to a second end;
      a cladding tube extending from the first end to the second end azimuthally around the central longitudinal axis, the cladding tube comprising (i) a cladding outer surface at a cladding outer radius from the central longitudinal axis, and (ii) a cladding inner surface at a cladding inner radius from the central longitudinal axis;
      a plurality of primary capillaries arranged azimuthally around the central longitudinal axis, each of the plurality of primary capillaries directly contacting the cladding inner surface and comprising (i) a primary capillary longitudinal axis that is parallel to the central longitudinal axis (ii) a primary capillary outer surface at a primary capillary outer radius from the primary capillary longitudinal axis, (iii) a primary capillary inner surface at a primary capillary inner radius from the primary capillary longitudinal axis and (iv) a primary capillary thickness; and
      an effective core region tangential to the plurality of primary capillaries having a core radius from the central longitudinal axis, the plurality of primary capillaries disposed radially outward of the effective core region;
      wherein the cladding tube or at least one of the plurality of primary capillaries comprises lossy glass, the lossy glass comprising an oxide and having an absorption coefficient a(λ) at a wavelength λ greater than 1×10⁻¹², the wavelength λ in the range from 800 nm to 2000 nm; and
   drawing a hollow-core optical fiber from the heated hollow-core assembly, the hollow-core optical fiber configured to guide an optical signal having the wavelength 2.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings are illustrative of selected aspects of the present description, and together with the specification serve to explain principles and operation of methods, products, and compositions embraced by the present description. Features shown in the drawing are illustrative of selected embodiments of the present description and are not necessarily depicted in proper scale.

### BRIEF DESCRIPTION OF THE DRAWINGS

While the specification concludes with claims particularly pointing out and distinctly claiming the subject matter of the written description, it is believed that the specification will be better understood from the following written description when taken in conjunction with the accompanying drawings, wherein:

FIG. 1 depicts a hollow-core assembly.

FIG. 2 depicts a cross-section taken at line II-II of the hollow-core assembly shown in FIG. 1.

FIG. 3A depicts a cross-section of a hollow-core assembly that includes nested capillaries.

FIG. 3B depicts an image of a hollow-core optical fiber with six primary capillaries, each of which includes a nested capillary.

FIG. 4 depicts a cross-section of a hollow-core assembly that illustrates selected geometric features.

FIGS. 5A and 5B depict methods of forming a hollow-core assembly from constituent elements.

FIG. 6 is a schematic diagram of a drawing step, illustrating drawing of a hollow-core optical fiber from a hollow-core preform.

FIG. 7 depicts confinement loss of the fundamental mode (LP01) at 1550 nm of a guided optical signal in a representative hollow-core optical fiber as a function of the absorption coefficient of the cladding tube.

FIG. 8 depicts confinement loss of the fundamental mode (LP01) at 1550 nm of a guided optical signal in a representative hollow-core optical fiber as a function of the absorption coefficient of the nested capillary.

FIG. 9 depicts confinement loss of the fundamental mode (LP01) at 1550 nm of a guided optical signal in a representative hollow-core optical fiber as a function of the absorption coefficient of the primary capillary.

The embodiments set forth in the drawings are illustrative in nature and not intended to be limiting of the scope of the detailed description or claims. Whenever possible, the same reference numeral will be used throughout the drawings to refer to the same or like feature. The claims as set forth below are incorporated into and constitute part of this Detailed Description.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified.

Disclosed are components (including materials, compounds, compositions, and method steps) that can be used for, in conjunction with, in preparation for, or as embodiments of the disclosed reflecting hollow-core assemblies and methods for making hollow-core assemblies. It is understood that when combinations or subsets, interactions of the components are disclosed, each component individually and each combination of two or more components is also contemplated and disclosed herein even if not explicitly stated. If, for example, if a combination of components A, B, and C is disclosed, then each of A, B, and C is individually disclosed as is each of the combinations A-B, B-C, A-C, and A-B-C. This understanding applies to all aspects of this disclosure including, but not limited to, components corresponding to materials, compounds, compositions, and steps in methods.

The construction and arrangement of the elements of the present disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel and nonobvious teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

In this specification and in the claims which follow, reference will be made to a number of terms which shall be defined to have the following meanings:

“Include,” “includes,” or like terms means encompassing but not limited to, that is, inclusive and not exclusive.

The term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The indefinite article “a” or “an” and its corresponding definite article “the” as used herein means at least one, or one or more, unless specified otherwise.

As used herein, “contact” refers to direct contact or indirect contact. Direct contact refers to contact in the absence of an intervening element and indirect contact refers to contact through one or more intervening elements. Elements in direct contact touch each other. Elements in indirect contact do not touch each other, but are otherwise joined to each other through one or more intervening materials. Elements in contact may be rigidly or non-rigidly joined. Contacting refers to placing two elements in direct or indirect contact. Elements in direct (indirect) contact may be said to directly (indirectly) contact each other.

“Optical fiber” refers to a waveguide that includes a core region surrounded by a cladding. An optical signal is guided in the core region and confined to the core region by the cladding.

“Hollow-core optical fiber” refers to an optical fiber with a core region that is not solid. Preferably, the core region is a gas.

“Anti-resonant hollow-core optical fiber” refers to a hollow-core optical fiber in which the cladding is configured to confine an optical signal to the core region by anti-resonance.

“Guided optical signal” refers to the optical signal confined to the hollow core of a hollow-core optical fiber.

“Confinement loss” refers to the confinement loss of the fundamental mode (LP01 mode) of the guided optical signal.

“Lossy glass” refers to glass having an absorption coefficient at a wavelength λ greater than the absorption coefficient of pure silica at the wavelength λ.

As used herein, “softening point” refers to the temperature at which a glass has a viscosity of 10^{7.6} Poise.

Reference will now be made in detail to the present illustrative embodiments, examples of which are illustrated in the accompanying drawings.

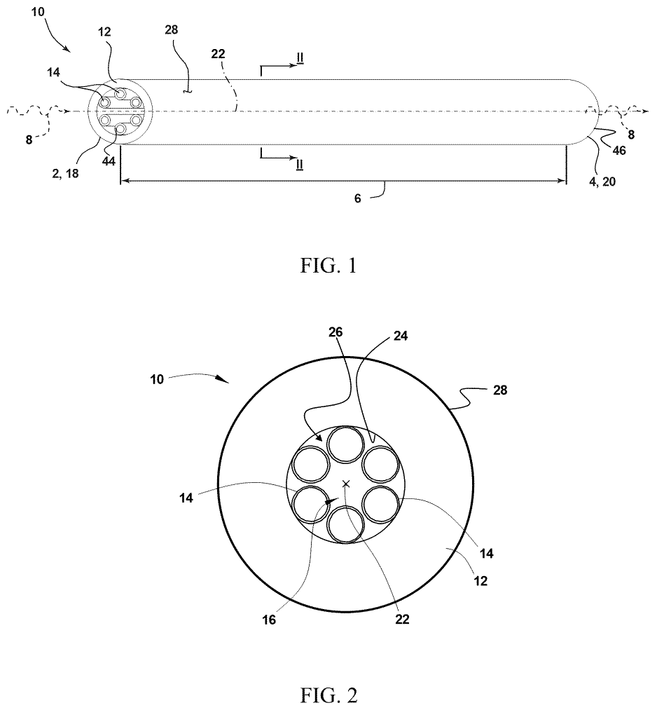

Referring to FIGS. 1-4, a hollow-core assembly 10 includes a cladding tube 12, one or more primary capillaries 14, and an effective core region 16. In embodiments, the hollow-core assembly 10 is a hollow-core blank, a hollow-core preform, or a hollow-core optical fiber. The hollow-core blank, the hollow-core preform, and the hollow-core optical fiber all share corresponding elements that differ in dimensions. The hollow-core blank has the largest dimensions and is typically the initial assembly of elements for draw of a hollow-core optical fiber. Tubes corresponding to the capillaries need to be large enough and sufficiently sturdy to handle without breaking. The primary capillary tubes are inserted into the interior cavity of a larger cladding tube, arranged in an azimuthal direction about the central longitudinal axis of the cladding tube, and fused to the inner surface of the cladding tube. Fusing can occur, for example, by flame treatment or laser welding.

Although convenient for handling and initial assembly, the dimensions of the hollow-core blank are far removed from the dimensions of the hollow-core optical fiber. Accordingly, in some processes, redraw of the hollow-core blank to form a hollow-core preform occurs and a hollow-core optical fiber is drawn from the hollow-core preform. Redraw of the hollow-core blank entails heating, softening, and drawing the hollow-core blank to reduce its dimensions (including the thickness and diameter of the primary capillary tubes and the cladding tube) to ranges closer to the dimensions of the hollow-core optical fiber. A hollow-core preform is an intermediate producing having dimensions that are intermediate between the corresponding dimensions of the hollow-core blank and the hollow-core optical fiber. Redraw narrows and elongates the hollow-core blank. A plurality of hollow-core preforms of specified length are sliced from the redrawn hollow-core blank and subsequently used for draw of a hollow-core optical fiber. Redraw of a hollow-core blank to form a hollow-core preform may occur in the same system used to draw the hollow-core optical fiber (online redraw) or in a separate system from the system used to draw the hollow-core optical fiber (offline redraw). Aside from dimensions, hollow-core blanks, hollow-core preforms, and hollow-core optical fibers have corresponding elements and geometry. Each represents an embodiment of a hollow-core assembly for purposes of the present disclosure. The ultimate objective is a hollow-core optical fiber, which may be drawn from a hollow-core blank or a hollow-core preform.

Referring further to FIGS. 1-4, a hollow-core assembly 10 includes a first end 2, a second end 4, and a length 6 extending between the first end 2 and the second end 4. The hollow-core assembly 10 further includes a central longitudinal axis 22 that is the radial center of the hollow-core assembly 10 and extends the length 6 of the hollow-core assembly 10. In general terms, the hollow-core assembly 10, when configured as a hollow-core optical fiber, is a waveguide that transmits electromagnetic radiation 8 that enters the first end 2 through the length 6 of the hollow-core assembly 10 and out of the hollow-core assembly 10 at the second end 4.

The length 6 of the hollow-core assembly 10 is not particularly limited and depends on the application. The length 6, for example, differs for hollow-core blanks, hollow-core preforms and hollow-core optical fibers. The length 6 of a hollow-core blank is typically on the order of a half meter to several meters. Hollow-core preforms are cut at arbitrary lengths from redrawn hollow-core blanks and are sized according to compatibility with a hollow-core optical fiber draw process. The length 6 of hollow-core preforms is typically on the order of a few centimeters to several meters. Hollow-core optical fibers are drawn from hollow-core preforms and have small diameters with large lengths. The length 6 of hollow-core optical fibers is typically on the order of several tens of meters to several hundred or thousand kilometers. Conditions for manufacturing hollow-core blanks, hollow-core preforms, and hollow-core optical fibers are sufficiently flexible to provide lengths over large ranges.

The hollow-core assembly 10 includes cladding tube 12. The cladding tube 12 is disposed radially around the central longitudinal axis 22. The cladding tube 12 includes a cladding first end 18, a cladding second end 20, a cladding inner surface 24, a cladding interior 26, a cladding outer surface 28, and a cladding thickness 30. The cladding inner surface 24 is at a cladding inner radius 32 from the central longitudinal axis 22. The cladding inner surface 24 extends between the cladding first end 18 and the cladding second end 20. The cladding inner surface 24 faces central longitudinal axis 22 and defines the cladding interior 26. The central longitudinal axis 22 extends through the cladding interior 26. The cladding outer surface 28 is at a cladding outer radius 34 from the central longitudinal axis 22. The cladding outer surface 28 extends from the cladding first end 18 to the cladding second end 20. The outer surface 28 is further away from the central longitudinal axis 22 than the inner surface 24. The cladding thickness 30 is measured radially from the central longitudinal axis 22 between the cladding inner surface 24 and the cladding outer surface 28.

The cladding tube 12 further includes primary capillaries 14. The primary capillaries 14 are disposed within the cladding tube 12 proximate to the inner surface 24 of the cladding tube 12. At least a portion of the primary capillaries 14 is disposed closer to the central longitudinal axis 22 of the hollow-core optical assembly 10 than the inner surface 24 of the cladding tube 12. The one or more primary capillaries 14 are disposed within the cladding interior 26.

Each of the one or more primary capillaries 14 includes a primary capillary first end 44, a primary capillary second end 46, a primary capillary longitudinal axis 48, a primary capillary inner surface 50, a primary capillary interior 52, a primary capillary outer surface 54, a primary capillary thickness 56, and a primary capillary aspect ratio. The primary capillary first end 44 is disposed near the cladding first end 18. The primary capillary second end 46 is disposed near the cladding second end 20. The primary capillary inner surface 50 is at a primary capillary inner radius 58 from the primary capillary longitudinal axis 48. The primary capillary inner surface 50 extends from the primary capillary first end 44 to the primary capillary second end 46. The primary capillary inner surface 50 faces the primary capillary longitudinal axis 48 and defines the primary capillary interior 52. The primary capillary longitudinal axis 48 is parallel to the cladding longitudinal axis 22. The primary capillary outer surface 54 is at a primary capillary outer radius 60 from the primary capillary longitudinal axis 48. The primary capillary outer surface 54 extends between the primary capillary first end 44 and the primary capillary second end 46. The primary capillary thickness 56 is measured radially from the primary capillary longitudinal axis 48 between the primary capillary inner surface 50 and the primary capillary outer surface 54. The primary capillary aspect ratio corresponds to a ratio of the primary capillary inner radius 58 to the primary capillary outer radius 60. For example, the primary capillary aspect ratio is the primary capillary inner radius 58 divided by the primary capillary outer radius 60.

The primary capillary outer surfaces 54 of the primary capillaries 14 collectively define an effective core region 16 of the hollow-core optical assembly 10. The effective core region 16 is referred to as such to distinguish it from the solid core region of conventional optical fibers and to signify that it is a space filled with a gas. The effective core region 16 extends to a core radius 62 from the central longitudinal axis 22. The core radius 62 is tangential to the primary capillary outer surface 54 of each of the one or more primary capillaries 14. The one or more primary capillaries 14 are disposed radially outward of the effective core region 16. When configured as a hollow-core optical fiber, most of the electromagnetic radiation 8 entering the first end 2 of the hollow-core optical assembly 10 is confined by and propagates through the length 6 thereof within the effective core region 16 to the second end 4.

In embodiments, a gap separates the primary capillary outer surfaces 54 of adjacent primary capillaries 14. All such gaps may be substantially the same in dimension in one embodiment. In other embodiments, the primary capillary outer surfaces 54 of adjacent primary capillaries 14 touch each other and may be fused together.

The hollow-core assembly 10 can have any number of primary capillaries 14. For example, the hollow-core assembly 10 can have one primary capillary 14 or at least one primary capillary 14. As another example, the hollow-core assembly 10 can have two primary capillaries 14, or at least two primary capillaries 14, or at least three primary capillaries 14, or at least four primary capillaries 14, or from one to ten primary capillaries 14, or from two to eight primary capillaries 14, or from three to seven primary capillaries 14. As other examples, the hollow-core assembly 10 can have three, four, five, six, seven, eight, or nine primary capillaries 14. The hollow-core assembly 10 can have more than nine primary capillaries 14. In embodiments, the primary capillary outer radius 60 of each of the one or more primary capillaries 14 is substantially the same (e.g., within manufacturing capability). In embodiments, the primary capillary thickness 56 of each of the one or more primary capillaries 14 is substantially the same (e.g., within manufacturing capability). In embodiments, each of the one or more primary capillaries 14 is substantially cylindrical (e.g., within manufacturing capability). In embodiments, each of the one or more primary capillaries 14 is fused to the cladding inner surface 24 and substantially evenly spaced from each other azimuthally about the cladding longitudinal axis 22.

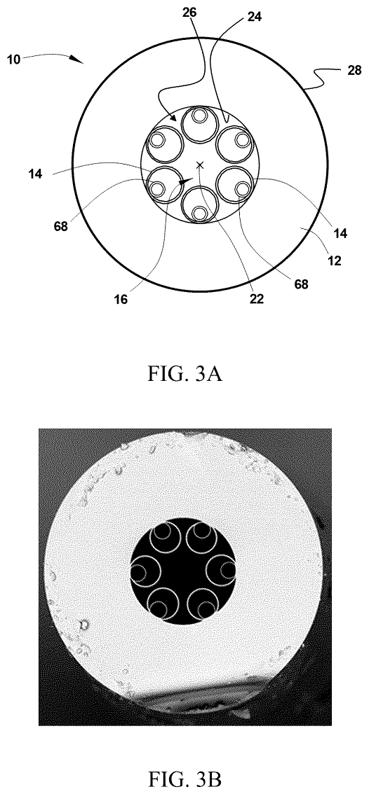

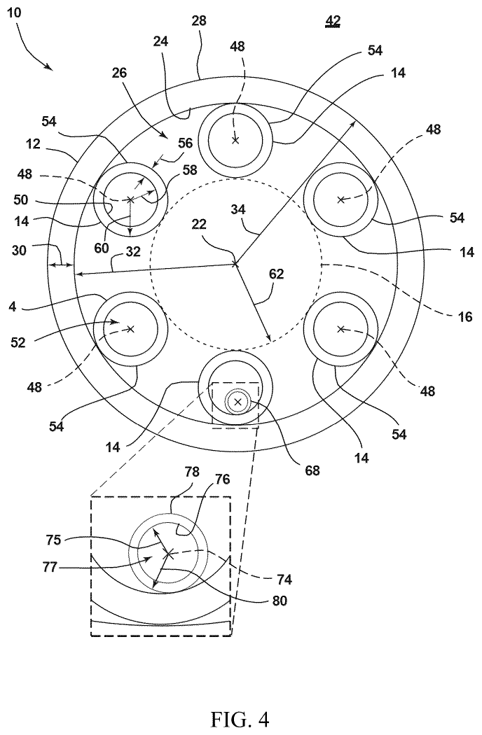

In embodiments, the hollow-core assembly 10 further includes one or more nested capillaries 68 (FIGS. 3A, 3B, and 4). Each of the one or more nested capillaries 68 is disposed within the primary capillary interior 52 of a different one of the one or more primary capillaries 14. In one embodiment, a nested capillary 68 is disposed in each primary capillary 14. Each nested capillary 68 includes a nested first end, a nested second end, a nested longitudinal axis 74, a nested inner surface 76, and a nested outer surface 78. The nested first end is disposed near the primary capillary first end 44. The nested second end is disposed near the primary capillary second end 46. The nested longitudinal axis 74 is parallel to the primary capillary longitudinal axis 48 and the central longitudinal axis 22. The nested inner surface 76 is disposed at a nested inner radius 75 from the nested longitudinal axis 74. The nested inner surface 76 defines a nested interior 77. The nested outer surface 78 is disposed at a nested outer radius 80 from the nested longitudinal axis 74. Nested capillaries 68 have a nested thickness corresponding to the difference between nested outer radius 80 and nested inner radius 75. FIG. 4 shows a cross-section with only one nested capillary 68 in order to maintain legibility. It should be understood that one, a plurality, or all of the one or more primary capillaries 14 can include one of the one or more nested capillaries 68 disposed therein (see, for example, FIGS. 3A and 3B).

When configured as a hollow-core optical fiber, representative dimensions of the hollow-core assembly are as follows:

The core radius 62 of effective core region 16 is within a range of from 10 μm to 25 μm. For example, the core radius 62 can be 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, or within any range bound by any two of those values (e.g., from 11 μm to 18 μm, from 14 μm to 17 μm, and so on).

The primary capillary outer radius 60 is within a range of from 5 μm to 35 μm. For example, the primary outer radius 52 can be 5 μm, 6 μm, 7 μm, 8 μm, 9 μm, 10 μm, 11 μm, 12 μm, 13 μm, 14 μm, 15 μm, 16 μm, 17 μm, 18 μm, 19 μm, 20 μm, 21 μm, 22 μm, 23 μm, 24 μm, 25 μm, 26 μm, 27 μm, 28 μm, 29 μm, 30 μm, 31 μm, 32 μm, 33 μm, 34 μm, 35 μm, or within any range bound by any two of those values (e.g., from 25 μm to 29 μm, from 18 μm to 24 μm, from 10 μm to 25 μm, from 5 μm to 20 μm, from 10 μm to 35 μm, from 12 μm to 20 μm, and so on).

The primary capillary thickness 56 is within a range of from 0.25 μm to 5.00 μm. For example, the primary capillary thickness 56 is 0.25 μm, 0.50 μm, 0.75 μm, 1.00 μm, 1.25 μm, 1.50 μm, 1.75 μm, 2.00 μm, 2.25 μm, 2.50 μm, 2.75 μm, 3.00 μm, 3.25 μm, 3.50 μm, 3.75 μm, 4.00 μm, 4.25 μm, 4.50 μm, 4.75 μm, 5.00 μm, or within any range bound by any two of those values (e.g., from 0.50 μm to 4.75 μm, from 0.75 μm to 4.50 μm, from 1.00 μm to 5.00 μm, from 1.50 μm to 4.00 μm, and so on). In embodiments, the primary capillary thickness 56 is within ±30%, ±25%, ±20%, ±15%, ±10%, or ±5% of a calculated thickness t as defined by an equation that governs confinement of an optical signal in the effective core region 16 by anti-resonance:

$$t = \frac{( 2 m - 1 ) λ}{4 \sqrt{{n}^{2} - 1}} \qquad ( 1 )$$

where t is the calculated thickness, m is an integer (e.g., 1, 2, 3, . . . ) corresponding to the order of antiresonance, λ is the wavelength of the guided optical signal in the hollow core of the hollow-core assembly), and n is the refractive index of the primary capillaries 14 at the wavelength λ. The wavelength λ is between 800 nm and 2000 nm. In one embodiment, the wavelength A is 1550 nm.

The nested outer radius 80 is within a range of from 5 μm to 15 μm. For example, the first nested outer radius 78 can be 5 μm, 6 μm, 7 μm, 8 μm, 9 μm, 10 μm, 11 μm, 12 μm, 13 μm, 14 μm, 15 μm, or within any range bound by any two of those values (e.g., from 6 μm to 12 μm, from 8 μm to 14 μm, and so on). The nested thickness of nested capillaries 68 corresponds to primary capillary thickness 58.

The gap separating the primary capillary outer surfaces 54 of adjacent primary capillaries 14 is within a range of from 0.0 μm to 5.0 μm. For example, the gap can be 0.0 μm, 0.5 μm, 1.0 μm, 1.5 μm, 2.0 μm, 2.5 μm, 3.0 μm, 3.5 μm, 4.0 μm, 4.5 μm, 5.0 μm, or within any range bound by any two of those values.

The cladding outer radius 34 is within a range of from 50 μm to 500 μm. For example, the cladding outer radius 34 can be 50 μm, 55 μm, 60 μm, 62.5 μm, 65 μm, 70 μm, 75 μm, 100 μm, 125 μm, 150 μm, 250 μm, 300 μm, 350 μm, 400 μm, 450 μm, 500 μm, or within any range bound by any two of those values (e.g., from 50 μm to 150 μm, from 62.5 μm to 125 μm, and so on).

The cladding inner radius 32 is within a range of from 40 μm to 125 μm. For example, the cladding inner radius 32 can be 40 μm, 45 μm, 50 μm, 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, or within any range bound by any two of those values (e.g., from 45 μm to 65 μm, from 50 μm to 60 μm, and so on).

When configured as a hollow-core blank or a hollow-core preform for drawing a hollow-core optical fiber, dimensions of the hollow-core assembly are scaled up variations of the dimensions set forth for the hollow-core optical fiber. Flexibility in the scale up is envisioned with scale up factors over a wide range being operable. Dimensions (inner radius, outer radius, thickness) of components (cladding tube, primary capillaries, nested capillaries) of the hollow-core preform relative to corresponding components of the hollow-core optical fiber are larger by a scaling factor greater than or equal to 2, or greater than or equal to 5, or greater than or equal to 10, or greater than or equal to 25, or greater than or equal to 50, or greater than or equal to 75, or greater than or equal to 100, or greater than or equal to 200, or greater than or equal to 400, or greater than or equal to 600, or greater than or equal to 800, or greater than or equal to 1000, or in a range from 10 to 2000, or in a range from 20 to 1500, or in a range from 30 to 1000, or in a range from 40 to 500, or in a range from 50 to 400. By way of example, if the thickness of a feature in a hollow-core optical fiber is 1 μm and the scaling factor is 10, the thickness of the corresponding feature in the hollow-core blank or hollow-core preform is 10 μm. In different embodiments, the scaling factors disclosed herein for the hollow-core blank or hollow-core preform are applicable to the dimension of any component of a hollow-core fiber disclosed herein. A different scaling factor may be applicable to different components.

In representative embodiments, when configured as a hollow-core preform for hollow-core optical fiber, the hollow-core assembly has: a cladding outer radius 34 in a range from 2.5 mm to 175 mm, or in a range from 5.0 mm to 150 mm, or in a range from 7.5 mm to 125 mm, or in a range from 10 mm to 100 mm, or in a range from 15 mm to 75 mm; a cladding inner radius 32 in a range from 1.5 mm to 165 mm, or in a range from 2.5 mm to 150 mm, or in a range from 5.0 mm to 125 mm, or in a range from 7.5 mm to 100 mm; or in a range from 10 mm to 75 mm, or in a range from 12.5 mm to 50 mm; a primary capillary outer radius 60 within in a range from 0.5 mm to 75 mm, or in a range from 1.5 mm to 60 mm, or in a range from 2.5 mm to 50 mm; or in a range from 3.5 mm to 40 mm, or in a range from 5.0 mm to 30 mm; or in a range from 7.5 mm to 25 mm, or in a range from 10 mm to 20 mm; a primary capillary inner radius 58 in a range from 0.5 mm to 65 mm, or in a range from 1.0 mm to 50 mm, or in a range from 2.5 mm to 40 mm; or in a range from 5.0 mm to 30 mm, or in a range from 7.5 mm to 20 mm; a primary capillary thickness 56 and a nested thickness in a range from 25 μm to 1000 μm, or in a range from 50 μm to 800 μm, or in a range from 100 μm to 600 μm, or in a range from 150 μm to 400 μm, and a nested outer radius 80 in a range from 0.5 mm to 35 mm, or in a range from 1.0 mm to 25 mm, or in a range from 2.0 mm to 20 mm, or in a range from 5.0 mm to 15 mm, or in a range from 7.5 mm to 12.5 mm.

In representative embodiments, when configured as a hollow-core blank for hollow-core optical fiber, the hollow-core assembly has the same or greater dimensions for corresponding elements relative to the dimensions of the hollow-core preform noted above. Dimensions of the hollow-core blank are greater than or equal to corresponding dimensions of the hollow-core preform noted above by a factor of at least 1.0, or a factor of at least 2.0, or a factor of at least 4.0, or a factor of at least 6.0, or a factor of at least 8.0, or a factor of at least 10.0, or a factor in the range from 1.0 to 20.0, or a factor in the range from 2.0 to 16.0, or a factor in the range from 3.0 to 12.0, or a factor in the range from 4.0 to 10.0.

In representative embodiments, when configured as a hollow-core blank for hollow-core optical fiber, the hollow-core assembly has: a cladding outer radius 34 in a range from 10 mm to 500 mm, or in a range from 12.5 mm to 250 mm, or in a range from 15 mm to 200 mm, or in a range from 17.5 mm to 150 mm, or in a range from 20 mm to 125 mm; a cladding inner radius 32 in a range from 7.5 mm to 400 mm, or in a range from 7.5 mm to 200 mm, or in a range from 10 mm to 175 mm, or in a range from 12.5 mm to 150 mm; a primary capillary outer radius 60 in a range from 5.0 mm to 80 mm, or in a range from 6.0 mm to 70 mm, or in a range from 7.0 mm to 60 mm; or in a range from 8.0 mm to 50 mm, or in a range from 9.0 mm to 40 mm; or in a range from 10 mm to 30 mm, or in a range from 11 mm to 20 mm; a primary capillary inner radius 58 in a range from 1.0 mm to 100 mm, or in a range from 2.0 mm to 85 mm, or in a range from 3.0 mm to 70 mm; or in a range from 4.0 mm to 55 mm, or in a range from 5.0 mm to 40 mm; a primary capillary thickness 56 and a nested thickness in a range from 0.5 mm to 16 mm, or in a range from 1.0 mm to 12 mm, or in a range from 1.5 mm to 8.0 mm, or in a range from 2.0 mm to 6.0 mm, or and a nested outer radius 80 in a range from 2.5 mm to 40 mm, or in a range from 3.0 mm to 30 mm, or in a range from 3.5 mm to 20 mm, or in a range from 4.0 mm to 15 mm, or in a range from 5.0 mm to 10 mm.

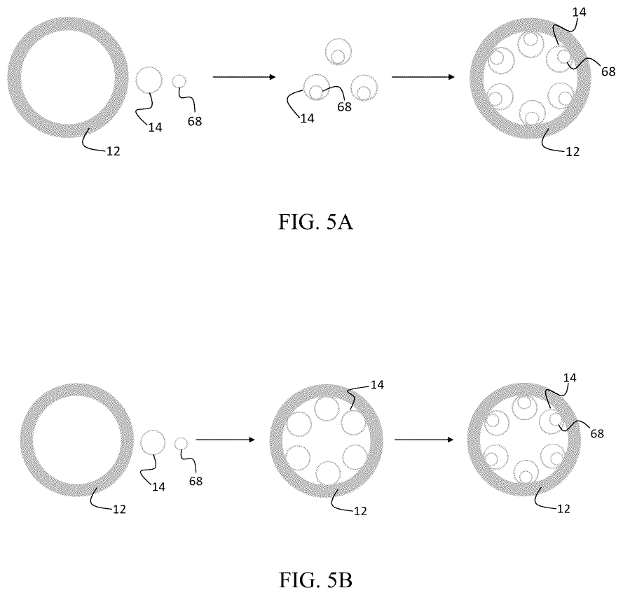

FIGS. 5A and 5B depict fabrication of a hollow-core assembly. Fabrication begins with selection of the constituent elements of the hollow-core assembly. The constituent elements include a cladding tube 12, one or more primary capillaries 14, and optionally one or more nested capillaries 68. At least one of the constituent elements has an absorption coefficient within the ranges disclosed herein. After selection of the constituent elements, fabrication continues with a step of combining constituent element. FIG. 5A depicts forming anti-resonant cladding elements by inserting nested capillaries 68 into primary capillaries 14 and attaching nested capillaries 68 to primary capillaries 14. Attachment of nested capillaries 68 to primary capillaries 14 is achieved, for example, by fusing or bonding nested capillaries 68 to primary capillaries 14. Methods of attachment include flame welding and laser welding. After attachment, the anti-resonant elements are positioned and arranged within cladding tube 12 and attached to an inner surface thereof to form a hollow-core assembly. FIG. 5B shows an alternative process in which primary capillaries 14 are first positioned, arranged, and attached to the inner surface of cladding tube 12. Nested capillaries 68 are then positioned within and fused to primary capillaries 14. The resulting hollow-core assembly is a hollow-core blank or hollow-core preform for fabricating hollow-core optical fibers.

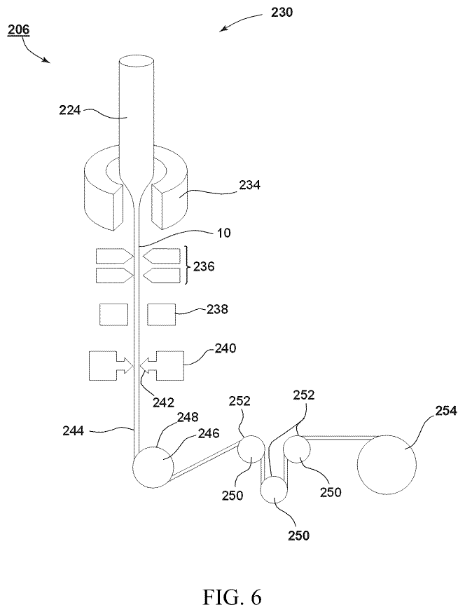

Formation of a hollow-core optical fiber from the hollow-core blank or the hollow-core preform includes a drawing step 206 performed using a draw system 230 (FIG. 6). The draw system 230 can include a furnace for heating the hollow-core blank or hollow-core preform 224 to melt or soften the cladding tube and the plurality of capillaries of the hollow-core blank or hollow-core preform 224. The furnace 232 can be disposed in a draw tower. In embodiments, the furnace 232 includes a heater 234 such that the hollow-core blank or the hollow-core preform 224 is consumed and drawn into the hollow-core optical fiber 10 as it is lowered towards the heater 234. In other embodiments, a hollow-core blank is redrawn to form a hollow-core preform in furnace 232 and the hollow-core optical fiber 10 is drawn from the hollow-core preform. The draw system 230 can further include non-contact measurement sensors 236 for measuring the size (e.g., cladding outer radius 32) of the hollow-core optical fiber 10 that exits the furnace 232. A cooling station 238 can reside downstream of the measurement sensors 236 and is configured to cool the hollow-core optical fiber 10. A coating station 240 can reside downstream of the cooling station 238. The coating station 240 is configured to deposit a protective coating material 242 onto the hollow-core optical fiber 10 to form a coated hollow-core optical fiber 244. A tensioner 246 resides downstream of the coating station 240. The tensioner 246 has a surface 248 that pulls (draws) the coated hollow-core optical fiber 244. A set of guide wheels 250 with respective surfaces 252 resides downstream of the tensioner 246. The guide wheels 250 serve to guide the coated hollow-core optical fiber 244 to a fiber take-up spool 254 to store the coated hollow-core optical fiber 244. The draw speed of drawing the hollow-core optical fiber from the hollow-core blank or the hollow-core preform is greater than 0.5 m/s, or greater than 1.0 m/s, or greater than 2.5 m/s, or greater than 5.0 m/s, or greater than 10 m/s, or greater than 15 m/s, or greater than 20 m/s, or in a range from 0.5 m/s to 25 m/s, or in a range from 1.0 m/s to 20 m/s, or in a range from 2.5 m/s to 15 m/s.

Constitutive elements of the hollow-core assembly include the cladding tube and primary capillaries. In preferred embodiments, constituent elements of the hollow-core assembly further include nested capillaries positioned within the primary capillaries. One or more nested capillaries may be positioned within one or more of the primary capillaries. To facilitate draw of hollow-core optical fibers from hollow-core blanks or hollow-core preforms, or redraw of hollow-core blanks to form hollow-core preforms, it is desirable to select glass compositions for the constitutive elements that have low softening points. Pure silica has a high softening point and requires high temperatures to process. The softening point of pure silica can be lowered through compositional variations. Silica that includes additives that lower the softening point relative to pure silica is referred to herein as “extrinsic silica”. Such additives include network formers, network modifiers, dopants, and impurities. Exemplary additives capable of reducing the softening point of silica include boron, phosphorous, water or hydroxyl groups, aluminum, and transition metals. Examples of extrinsic silica include borosilicates, phosphosilicates, aluminosilicates, aluminoborosilicates, and transition metal silicates. Other oxide glasses have a softening point less than the softening point of pure silica. For example, oxide glass systems other than those based on silica also have softening points less than the softening point of pure silica. Examples of such oxide glass systems include phosphates and borates. Fabricating hollow-core assemblies from oxide glasses, including extrinsic silica or non-silicate glass systems, having a softening point less than the softening point of pure silica reduces the processing temperatures needed for draw and redraw processes.

Alternatives to pure silica have been heretofore discouraged in the art due to concerns of introducing loss mechanisms that detract from the performance of hollow-core optical fibers. In particular, concerns over absorption of the optical signal guided by the hollow core of the hollow-core optical fiber by additives (or defects accompanying incorporation of additives) of extrinsic silica or certain components of oxides and non-silicate glass systems have been raised. Absorption of the guided optical signal by primary capillaries, nested capillaries, and/or cladding tube introduces a loss mechanism that reduces confinement of the guided optical signal in the hollow core of the hollow-core optical fiber. Absorption causes a small fraction of the guided optical signal to be absorbed by the cladding elements and dissipation (typically by a thermal mechanism) of the optical signal in the cladding (primary capillaries, nested capillaries and/or cladding tube).

In the course of work supporting the present disclosure, it has been observed, however, that the confinement loss of the guided optical signal remains low over an appreciable range of concentration of additives or glass components capable of absorbing the guided optical signal. To quantify the extent to which the glass of the constituent elements of a hollow-core optical fiber can tolerate absorption of the guided optical signal without a meaningful increase in confinement loss, we note that the refractive index ñ(λ) of glass can be expressed

$$\tilde{n} λ = n ( λ ) + i a ( λ ) \qquad ( 2 )$$

where n(λ) is the real part of the refractive index, a(λ) is the imaginary part of the refractive index, and λ is the wavelength, which corresponds to the wavelength of the guided optical signal. a(λ) accounts for absorption by the glass of the guided optical signal at the wavelength λ and is also referred to herein as the “absorption coefficient” of the glass. The absorption coefficient is zero for a non-absorbing glass and increases as the extent of absorption of the guided optical signal by the glass increases. For purposes of the present disclosure, the guided mode of interest is the fundamental mode (LP01). For reference purposes, at a wavelength of 1550 nm, the absorption coefficient of the fundamental mode in pure silica is less than 5×10⁻¹³. The absorption coefficients of the fundamental mode of modified forms of silica commonly used in conventional optical fiber (F-doped silica and alkali-doped silica) are also less than 5×10⁻¹³ at a wavelength of 1550 nm. The complex refractive index ñ(λ), including resolution into the real part n(λ) and imaginary part a(λ), can be measured by techniques known in the art. (See, for example, “Method for measuring small optical absorption coefficients with use of a Shack-Hartmann wave-front detector” by S. Yoshida et al., Applied Optics 42 (24) 4835 (2003).)

To illustrate the effect of the absorption coefficient a(λ) on confinement loss, we consider a representative hollow-core optical fiber having the design shown in FIG. 3A, which corresponds to an embodiment of FIG. 4 in which each primary capillary includes a nested capillary. As shown in FIGS. 3A and 4, the representative hollow-core optical fiber included six anti-resonant elements defining a hollow core. The anti-resonant elements were equally spaced in an azimuthal direction about the centerline of the representative hollow-core optical fiber. Each anti-resonant element included a primary capillary and a single nested capillary. Dimensions of the representative hollow-core optical fiber were as follows, where the feature label corresponds to reference numerals shown in FIG. 4:

| Dimension (feature label) | Magnitude | |
|---|---|---|
| Core radius (62) | 17.5 | μm |
| Primary capillary outer radius (60) | 15.0 | μm |
| Primary capillary thickness (56) | 550 | nm |
| Nested capillary outer radius (80) | 7.125 | μm |
| Nested capillary thickness (56) | 550 | nm |
| Cladding inner radius (32) | 47.5 | μm |

To model the confinement loss of the representative hollow-core optical fiber, we utilized COMSOL Multiphysics® software. The software implements a full vectorial finite element method. To determine confinement loss, a perfectly matched layer was used to simulate an infinite glass cladding outside of the modelling domain of the representative hollow-core optical fiber. The input to the model was the refractive index of the glass as stated in Eq. (2). The real part n(λ) was assumed to correspond to pure silica and the imaginary part a(λ) (absorption coefficient) was varied as described below to simulate the effect of absorption by the glass on confinement loss. Using the refractive index with the dimensions and geometry of the representative hollow-core optical fiber, the model computed the effective index of the fundamental mode at the wavelength λ. The effective index included a real

$${n}_{R e a l}^{eff} ( λ )$$

and an imaginary part

$${n}_{Im}^{eff} ( λ ) .$$

Confinement loss α_{CL}(λ) of the fundamental mode due to absorption by the glass can be expressed

$${α}_{C L} ( λ ) ( \frac{dB}{km} ) = \frac{20}{ln ( 10 )} \frac{2 π}{λ} \times {n}_{Im}^{eff} ( λ ) \times {10}^{9} \qquad ( 3 )$$

where the wavelength λ is expressed in units of μm (microns). In the examples that follow, the guided mode is assumed to be the fundamental mode (LP01), the wavelength λ of the guided fundamental mode is selected to be 1.55 μm and confinement loss is computed using Eq. (3). Although the examples that follow are based on a hollow-core optical fiber of a particular design operating at a particular wavelength λ, the principles and conclusions are applicable generally to hollow-core optical fibers of any design operating at any wavelength λ. Preferred wavelengths λ of operation, corresponding to the wavelength λ of the guided optical signal, are wavelengths λ in the range from 800 nm to 2000 nm, or in the range from 1000 nm to 1800 nm, or in the range from 1200 nm to 1700 nm, or in the range from 1400 nm to 1600 nm.

The effect of absorption by a constitutive element on confinement loss of the representative hollow-core optical fiber is expected to differ depending on the position of the constitutive element relative to the effective core region. The closer a constitutive element is to the effective core region, the greater the influence of absorption by the constative element on confinement of the guided optical signal in the effective core region. The primary capillaries are positioned closest to the effective core region and are expected to increase confinement loss α_{CL}(λ) to the greatest extent at a given absorption coefficient a(λ). The cladding tube, in contrast, is positioned further away from the effective core region so absorption by the cladding tube is expected to have a weaker influence on confinement. The effect of absorption by the nested capillaries on confinement is expected to be intermediate between the effects of the primary capillaries and cladding tube.

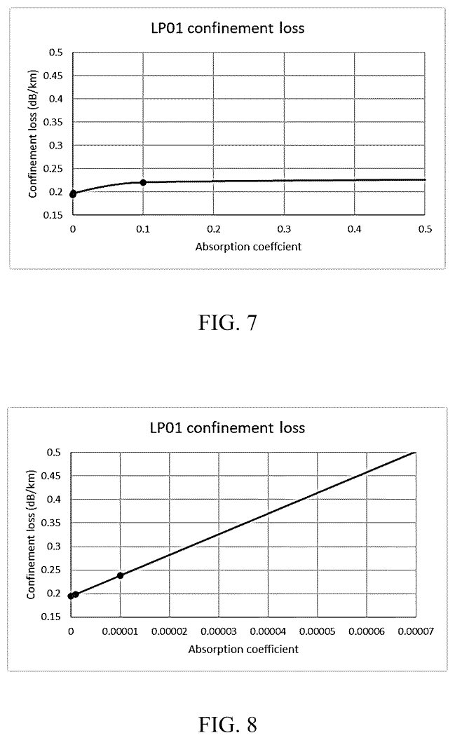

FIG. 7 illustrates the effect of the absorption coefficient of the cladding tube on confinement loss α_{CL}(λ) of the representative hollow-core optical fiber operating at a wavelength λ of 1550 nm. In FIG. 7, only the absorption coefficient a(λ) of the cladding tube was varied. The primary and nested capillaries were modelled as pure silica. The data point at an absorption coefficient a(λ) of zero is a reference data point in which the entire representative hollow-core optical fiber is made from pure silica. As the absorption coefficient a(λ) of the cladding tube was increased from the pure silica reference state to 0.1, only a slight increase in confinement loss α_{CL} (λ) was observed. Further increases in the absorption coefficient a(λ) of the cladding tube above 0.1 led to negligible increases in confinement loss α_{CL}(λ).

The results presented in FIG. 7 indicate that requiring use of pure silica for the cladding tube of hollow-core optical fibers provides essentially no advantage in maintaining confinement of the guided optical signal in the core. The absorption coefficient a(λ) of the cladding tube at 1550 nm can be well above the absorption coefficient a(λ) of pure silica (5×10⁻¹³) without significantly increasing confinement loss α_{CL}(λ). Glass having an absorption coefficient a(λ) greater than the absorption coefficient a(λ) of pure silica is referred to herein as “lossy glass”. Embodiments of lossy glass include oxides such as extrinsic silica, borosilicates, phosphosilicates, phosphates, and borates. In various embodiments, the cladding tube is made from lossy glass having an absorption coefficient a(λ) greater than 1×10⁻¹², or greater than 1×10⁻¹⁰, or greater than 1×10⁻⁸, or greater than 1×10⁻⁶, or greater than 1×10⁻⁴, or greater than 1×10⁻², or greater than 1×10⁻¹, or in the range from 1×10⁻¹² to 1, or in the range from 1×10⁻¹⁰ to 0.5, or in the range from 1×10⁻⁸ to 1×10⁻¹, or in the range from 1×10⁻⁶ to 1×10⁻².

FIG. 8 illustrates the effect of the absorption coefficient a(λ) of the nested capillary on confinement loss α_{CL}(λ) of the representative hollow-core optical fiber operating at a wavelength λ of 1550 nm. In FIG. 8, only the absorption coefficient a(λ) of the nested capillary was varied. The absorption coefficient a(λ) of each nested capillary was varied and the same absorption coefficient a(λ) was used for all six nested capillaries of the representative hollow-core optical fiber. The primary capillaries and cladding tube were modelled as pure silica. The data point at an absorption coefficient of zero is a reference data point in which the entire representative hollow-core optical fiber is made from pure silica. As the absorption coefficient a(λ) of the nested capillaries was increased from the pure silica reference state, an approximately linear increase in confinement loss α_{CL}(λ) was observed. To maintain a confinement loss α_{CL}(λ) less than 0.5 dB/km, nested capillaries made from glass with an absorption coefficient a(λ) up to 7×10⁻⁵ can be used.

The results presented in FIG. 8 indicate that requiring use of pure silica for the nested capillaries of hollow-core optical fibers provides only a small advantage in maintaining confinement of the guided optical signal in the core. The absorption coefficient a(λ) of the nested capillaries at 1550 nm can be well above the absorption coefficient a(λ) of pure silica (5×10⁻¹³) while still maintaining low confinement loss α_{CL}(λ). In various embodiments, the nested capillaries are made from lossy glass having an absorption coefficient a(λ) greater than 1×10⁻¹², or greater than 1×10⁻¹⁰, or greater than 1×10⁻⁸, or greater than 1×10⁻⁶, or greater than 1×10⁻⁵, or greater than 5×10⁻⁵, or in the range from 1×10⁻¹² to 1×10⁻⁴, or in the range from 1×10⁻¹⁰ to 5×10⁻⁵, or in the range from 1×10⁻⁹ to 1×10⁻⁵, or in the range from 1×10⁻⁸ to 5×10⁻⁶.

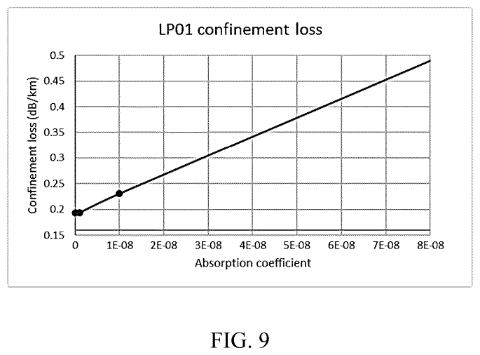

FIG. 9 illustrates the effect of the absorption coefficient a(λ) of the primary capillary on confinement loss α_{CL}(λ) of the representative hollow-core optical fiber operating at a wavelength λ of 1550 nm. In FIG. 9, only the absorption coefficient a(λ) of the primary capillary was varied. The absorption coefficient a(λ) of each primary capillary was varied and the same absorption coefficient a(λ) was used for all six primary capillaries of the representative hollow-core optical fiber. The nested capillaries and cladding tube were modelled as pure silica. The data point at an absorption coefficient of zero is a reference data point in which the entire representative hollow-core optical fiber is made from pure silica. As the absorption coefficient a(λ) of the primary capillaries was increased from the pure silica reference state, an approximately linear increase in confinement loss α_{CL}(λ) was observed. To maintain a confinement loss α_{CL}(λ) less than 0.5 dB/km, primary capillaries made from glass with an absorption coefficient a(λ) up to about 8×10⁻⁸ can be used.

The results presented in FIG. 9 indicate that requiring use of pure silica for the primary capillaries of hollow-core optical fibers provides only a modest advantage in maintaining confinement of the guided optical signal in the core. The absorption coefficient a(λ) of the primary capillaries at 1550 nm can be well above the absorption coefficient a(λ) of pure silica (5×10⁻¹³) while still maintaining low confinement loss α_{CL}(λ). In various embodiments, the primary capillaries are made from lossy glass having an absorption coefficient a(λ) greater than 1×10⁻¹², or greater than 1×10⁻¹¹, or greater than 1×10⁻¹⁰, or greater than 1×10⁻⁹, or greater than 1×10⁻⁸, or greater than 5×10⁻⁸, or in the range from 1×10⁻¹² to 1×10⁻⁷, or in the range from 5×10⁻¹¹ to 5×10⁻⁸, or in the range from 1×10⁻¹¹ to 1×10⁻⁸, or in the range from 5×10⁻¹⁰ to 5×10⁻⁹.

The limited effect of absorption of the constituent elements (cladding tube, nested capillaries, primary capillaries) on confinement loss α_{CL}(λ) of hollow-core optical fibers enables the use of lossy glass for the constituent elements in hollow-core assemblies. The constituent elements may be constructed, for example, from extrinsic silica or non-silicate glass systems. The availability of such alternatives to pure silica reduces the cost of the constituent elements and relaxes the conditions needed to process the constituent elements during redraw or draw.

Hollow-core assemblies as disclosed herein include embodiments in which at least one constituent element is made from lossy glass having an absorption coefficient a(λ) within the ranges disclosed herein. In first embodiments, at least the cladding tube, and/or at least one of the primary capillaries, and/or at least one of the nested capillaries is made from lossy glass having an absorption coefficient a(λ) within the ranges disclosed herein. In second embodiments, at least the cladding tube, and/or at least two of the primary capillaries, and/or at least two of the nested capillaries is made from lossy glass having an absorption coefficient a(λ) within the ranges disclosed herein. In third embodiments, at least the cladding tube, and/or at least three of the primary capillaries, and/or at least three of the nested capillaries is made from lossy glass having an absorption coefficient a(λ) within the ranges disclosed herein.

In other embodiments, at least the cladding tube, and/or at least one of the primary capillaries, and/or a plurality of the nested capillaries is made from lossy glass having an absorption coefficient a(λ) within the ranges disclosed herein. In still other embodiments, at least the cladding tube, and/or a plurality of the primary capillaries, and/or at least one of the nested capillaries is made from lossy glass having an absorption coefficient a(λ) within the ranges disclosed herein. In further embodiments, at least the cladding tube, and/or all of the primary capillaries, and/or at least one of the nested capillaries is made from lossy glass having an absorption coefficient a(λ) within the ranges disclosed herein. In still other embodiments, at least the cladding tube, and/or at least one of the primary capillaries, and/or all of the nested capillaries is made from lossy glass having an absorption coefficient a(λ) within the ranges disclosed herein.

The constituent elements of the hollow-core assembly having an absorption coefficient a(λ) within the ranges disclosed herein may comprise the same or different lossy glass composition. Multiple glass compositions other than or in addition to pure silica may be included among the constituent elements of the hollow-core assembly. In embodiments, glass compositions contained in the hollow-core assembly include two or more, or three or more, or four or more variations of extrinsic silica where the variations in extrinsic silica differ in the concentration and/or type of additive that acts to increase the absorption coefficient of the glass relative to pure silica. In embodiments, glass compositions included in the hollow-core assembly include extrinsic silica and a non-silicate glass, or combinations of two or more non-silicate glasses.

Lossy glass, such as extrinsic silica or non-silicate glass compositions having absorption coefficients a(λ) within the ranges disclosed herein, has a lower softening point than pure silica. The softening point of pure silica is higher than 1700° C. Lossy glass having absorption coefficients a(λ) within the ranges disclosed herein have softening points less than 1650° C., or less than 1600° C., or less than 1550° C., or less than 1500° C., or less than 1450° C., or less than 1400° C., or less than 1350° C., or less than 1300° C., or less than 1250° C., or less than 1200° C., or in the range from 1000° C. to 1650° C., or in the range from 1050° C. to 1600° C., or in the range from 1100° C. to 1550° C.

The reduced softening point of lossy glass simplifies the processing conditions required to form the constituent elements of hollow-core assemblies. Pure silica is typically made through a chemical vapor deposition process using high purity starting materials (e.g., SiCl₄ or octamethylcyclotetrasiloxane). As a result, production of pure silica is expensive. Fabrication of the constituent elements of hollow-core assemblies from lossy glass is possible using starting materials that include impurities to a degree to remain within the ranges of absorption coefficient a(λ) disclosed herein. In addition, when forming extrinsic silica by a soot-based technique, the soot does not need to be dried (e.g., with chlorine) to remove water or hydroxyl groups in the consolidation process. Water and hydroxyl groups can remain as additives in silica. Relaxation of purity requirements reduces the cost of the starting materials and processing. The reduced softening point of lossy glass also enables a wider range of fabrication techniques for the constituent elements of hollow-core assemblies. In addition to chemical vapor deposition, techniques such as melting, extrusion, soot pressing, the Danner process, the Vello process, and sol-gel synthesis become viable. Residual impurities that may accompany such techniques can be tolerated up to levels that conform to the ranges of absorption coefficient a(λ) disclosed herein.

The low softening point of lossy glass also facilitates fabrication of the hollow-core assembly. As noted above in reference to FIGS. 5A and 5B, fabrication of the hollow-core assembly includes fusing of primary capillaries to a cladding tube and in preferred embodiments, fusing of nested capillaries to primary capillaries as well. The low softening point of lossy glass simplifies fabrication by lowering the temperature required for fusing. Fusing is typically accomplished by local heating (e.g., by a flame, resistive heater, laser, blackbody radiation) to soften or melt the constitutive elements being fused. Lower softening points allow for fusing at lower temperatures, which simplifies the process and expands the range of heating mechanisms. In various embodiments, heating to achieve fusing of constituent elements is accomplished by a flames, a laser, a resistive heater, or blackbody radiation.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or description that the steps are to be limited to a specific order, it is no way intended that any particular order be inferred.

It will be apparent to those skilled in the art that various modifications and variations can be made without departing from the spirit or scope of the illustrated embodiments. Since modifications, combinations, sub-combinations and variations of the disclosed embodiments that incorporate the spirit and substance of the illustrated embodiments may occur to persons skilled in the art, the description should be construed to include everything within the scope of the appended claims and their equivalents.

What is claimed is:

1. A hollow-core assembly comprising:
a central longitudinal axis extending from a first end to a second end;
a cladding tube extending from the first end to the second end azimuthally around the central longitudinal axis, the cladding tube comprising (i) a cladding outer surface at a cladding outer radius from the central longitudinal axis, and (ii) a cladding inner surface at a cladding inner radius from the central longitudinal axis;
a plurality of primary capillaries arranged azimuthally around the central longitudinal axis, each of the plurality of primary capillaries directly contacting the cladding inner surface and comprising (i) a primary capillary longitudinal axis that is parallel to the central longitudinal axis (ii) a primary capillary outer surface at a primary capillary outer radius from the primary capillary longitudinal axis, (iii) a primary capillary inner surface at a primary capillary inner radius from the primary capillary longitudinal axis and (iv) a primary capillary thickness; and
an effective core region tangential to the plurality of primary capillaries having a core radius from the central longitudinal axis, the plurality of primary capillaries disposed radially outward of the effective core region;
wherein the cladding tube or at least one of the plurality of primary capillaries comprises lossy glass, the lossy glass comprising an oxide and having an absorption coefficient a(λ) at a wavelength λ greater than 1×10⁻¹², the wavelength λ in the range from 800 nm to 2000 nm.

2. The hollow-core assembly of claim 1, wherein the lossy glass comprises extrinsic silica.

3. The hollow-core assembly of claim 1, wherein the lossy glass is a borosilicate, phosphosilicate, aluminosilicate, aluminoborosilicate, phosphate or borate.

4. The hollow-core assembly of claim 1, wherein the lossy glass has an absorption coefficient a(λ) at the wavelength λ greater than 1×10⁻⁶.

5. The hollow-core assembly of claim 1, wherein the cladding tube comprises the lossy glass.

6. The hollow-core assembly of claim 1, wherein at least one of the plurality of primary capillaries comprises the lossy glass.

7. The hollow-core assembly of claim 1, wherein each of the plurality of primary capillaries comprises the lossy glass.

8. The hollow-core assembly of claim 1, further comprising a nested capillary, the nested capillary disposed within one of the plurality of primary capillaries, the nested capillary having a nested outer radius.

9. The hollow-core assembly of claim 8, wherein the nested capillary comprises the lossy glass.

10. The hollow-core assembly of claim 8, wherein the hollow-core assembly comprises a plurality of the nested capillaries, each of the plurality of nested capillaries disposed within a different one of the plurality of primary capillaries.

11. The hollow-core assembly of claim 1, wherein the wavelength λ is in the range from 1400 nm to 1600 nm.

12. The hollow-core assembly of claim 1, wherein the hollow-core assembly is a hollow-core optical fiber, the hollow-core optical fiber configured to guide a fundamental mode of an optical signal at the wavelength λ.

13. The hollow-core assembly of claim 12, further comprising a nested capillary disposed in the interior of one of the plurality of primary capillaries, the nested capillary comprising the lossy glass.

14. A method of making a hollow-core optical fiber comprising:
heating a hollow-core assembly, the hollow-core assembly comprising:
a central longitudinal axis extending from a first end to a second end;
a cladding tube extending from the first end to the second end azimuthally around the central longitudinal axis, the cladding tube comprising (i) a cladding outer surface at a cladding outer radius from the central longitudinal axis, and (ii) a cladding inner surface at a cladding inner radius from the central longitudinal axis;
a plurality of primary capillaries arranged azimuthally around the central longitudinal axis, each of the plurality of primary capillaries directly contacting the cladding inner surface and comprising (i) a primary capillary longitudinal axis that is parallel to the central longitudinal axis (ii) a primary capillary outer surface at a primary capillary outer radius from the primary capillary longitudinal axis, (iii) a primary capillary inner surface at a primary capillary inner radius from the primary capillary longitudinal axis and (iv) a primary capillary thickness; and
an effective core region tangential to the plurality of primary capillaries having a core radius from the central longitudinal axis, the plurality of primary capillaries disposed radially outward of the effective core region;
wherein the cladding tube or at least one of the plurality of primary capillaries comprises lossy glass, the lossy glass comprising an oxide and having an absorption coefficient a(λ) at a wavelength A greater than 1×10⁻¹², the wavelength λ in the range from 800 nm to 2000 nm; and
drawing a hollow-core optical fiber from the heated hollow-core assembly, the hollow-core optical fiber configured to guide an optical signal having the wavelength λ.

15. The method of claim 14, wherein the lossy glass comprises extrinsic silica.

16. The method of claim 14, wherein the lossy glass is a borosilicate, phosphosilicate, aluminosilicate, aluminoborosilicate, phosphate or borate.

17. The method of claim 14, wherein the cladding tube comprises the lossy glass.

18. The method of claim 14, wherein at least one of the plurality of primary capillaries comprises the lossy glass.

19. The method of claim 14, wherein the hollow-core assembly further comprises a nested capillary, the nested capillary disposed within one of the plurality of primary capillaries, the nested capillary having a nested outer radius.

20. The method of claim 19, wherein the nested capillary comprises the lossy glass.
